(19) United States
(12) Patent Application Publication
(10) Pub. No.: US 2015/0136694 A1
(43) Pub. Date: May 21, 2015

(54) POINT OF GENERATION SMALL VOLUME BIOREACTOR FOR HORMONE AND ENDOCRINE DISRUPTING CHEMICAL REMEDIATION

(71) Applicant: MICROBIAL REMEDIATION TECHNOLOGIES, INC., Bozeman, MT (US)

(72) Inventor: Renee Loretta LaFond, Bozeman, MT (US)

(73) Assignee: MICROBIAL REMEDIATION TECHNOLOGIES, INC., Bozeman, MT (US)

(21) Appl. No.: 14/082,284

(22) Filed: Nov. 18, 2013

(51) Int. Cl. C02F 3/10

(52) U.S. Cl. CPC C02F 3/104; C02F 3/106
USPC 210/617; 210/601; 210/151

(57) ABSTRACT

Water treatment and remediation processes for hormones and/or endocrine disrupting chemicals are disclosed. A bioreactor apparatus is provided having hormone degrading microbes suitable for forming a biofilm for such remediation processes wherein the water containing the hormones and/or endocrine disrupting chemicals provide a substrate for the biofilm. Methods of regenerating the bioreactors and filters for water treatment are disclosed. Additional applications of use for the water treatment and remediation include, for example, agricultural applications and consumer applications. Methods of employing the bioreactors and filters, methods of regenerating the bioreactor, kits, and assays for specific hormones and/or endocrine disrupting chemicals are also disclosed.

### FIELD OF THE INVENTION

The invention relates to water treatment, namely remediation processes for hormones and/or endocrine disrupting chemicals. In particular a carbon filter is used for removing the contaminants. In an instance, a bioreactor is seeded with hormone degrading microbes for such remediation processes. In another aspect, the hormone degrading microbes form a biofilm and waste water becomes the substrate (i.e. food) for the biofilm.

Beneficially, the water treatment is suitable for use at the source of contaminant introduction into the waste water, thereby removing and/or reducing the contaminant load on standard wastewater treatment plants. In additional aspects, the invention further includes methods of use, methods of regenerating the bioreactor, kits, and assays for specific hormones and/or endocrine disrupting chemicals.

### BACKGROUND OF THE INVENTION

Environmental estrogens include naturally occurring and synthetic compounds that elicit estrogenic responses by mimicking endogenous estradiol. Natural estrogens are excreted daily by females of reproductive age and livestock. However, there is a wide range of anthropogenic hormones entering our water sources as a result of the influences of humans on the natural world. These hormone mimicking compounds are referred to as endocrine disrupting chemicals (EDCs), because they bind to estrogen receptors, in some cases preferentially over the natural occurring hormones, in living organisms and trigger estrogenic effects.

Bioidentical and synthetic hormones are mass produced by pharmaceutical manufacturing facilities. Compounding pharmacies formulate and compound products for patient use. Examples of bioidentical hormones prescribed extensively for hormone replacement therapies (HRTs) are estrone (E1), 17b-estradiol (E2), estriol (E3), testosterone, progesterone, DHEA, and pregnenelone. Synthetic hormones, such as ethinyl estradiol (EE2), and mestranol are used as oral contraceptives. Other synthetic hormones include diethylstilbestrol (DES) are still used for veterinary applications. Taken orally or applied topically they enter our water supply through excretion, bathing or disposal (in the case of transdermal patches or expired drugs).

Additional sources of EDCs in the water supply include agriculture applications. Hormones are used for growth promotion and reproductive control of livestock, (i.e. cattle, pigs and chickens) and are naturally produced in mass quantities as a result of maintaining lactating animals for dairy production. Pesticides DDT, methoxychlor and chlordecone among others, are known EDCs. Several environmentally relevant compounds like alkylphenol polyethoxylates (APEs), and their derivatives nonylphenol, octylphenol, and nonylphenol polyethoxylates, for example, have been shown to have estrogenic activity. Some natural plants, such as soy beans, and fungal products are estrogenic. EDCs are discharged into aquatic environments by means of industrial effluents, municipal sewage treatment facilities, and as agricultural waste products, causing adverse effects on humans, wildlife and habitat.

Bioavailability and activity of hormones and EDCs in aquatic environments play a significant role in the degree of estrogenicity. Caldwell, D et al., Environ. Health Perspectives, 1181 (31) (2010). These emerging contaminants are currently unregulated despite increasing presence and concentrations in global sewage effluent, bed sediments, ground waters, surface waters and drinking water. Wennmalm, A et al., Drug Information Journal, 39, 291-297 (2005). Hormones are remarkably stable and effective at very low concentrations (nanograms) and environmental implications are staggering. Andersen, H. et al., Environ. Sci. & Tech., 37(18) 4021-4026 (2002). As demand for hormone replacement therapies continue to increase significantly, including estimated tripling of usage and/or production, in some commercial locations, the presence of hormones and EDCs will continue to increase.

The burden of hormone and EDC removal falls on conventional waste water treatment plants (WWTPs), which generally involves large scale addition of chemicals to a community waste water source, coagulation, flocculation, sedimentation, biological treatment, and/or disinfection. The Environmental Protection Agency (EPA) stipulates maximum contaminant release levels and state WWTPs abide by EPA regulations. The prevalence or hormones and EDCs is an emerging issue and there are no laws pertaining to the discharge or reclamation of these wastewaters. Adverse effects and increased public awareness compels WWTPs, which were not designed for hormone/EDC removal to address this issue. WWTPs are unable to sufficiently reduce and/or remove hormones and EDCs due to various factors, including for example: large volumes of the water to be treated; inadequate residence time; bioavailability of preferred substrates in comparison to the hormones for microorganisms; small particle size of hormones resulting in adherence to larger humic compounds making them unavailable for degradation; growth conditions which are not optimized for hormone remediation (i.e. pH, temperature and dissolved oxygen tailored for those microorganisms that degrade the larger constituents of activated sludge, such as organic and inorganic solids); etc. In light of these many deficiencies of conventional waste water treatments, some WWTPs have employed UV radiation to improve hormone removal; however this is an inordinately expensive process which may outweigh the increased resource and energy consumption, as well as produces unwanted eco-toxins (derivatives of hormones). Some studies have shown that mutagenic and toxic properties of photodegradation and photo oxidation processes generate more environmental impact than they remove. Advantages and disadvantages of other removal technologies involve ozonation, filtration, application of powdered charcoal and constructed wetlands have been explored, but they all have shortcomings. In general, it is insufficient to direct all hormone contaminant treatment efforts solely to WWTPs.

Other types of endpoint remediation for hormones have included reverse osmosis (RO) and/or nanofiltration (NF) for hormone removal. Despite showings of efficacy of up to 95% for removal of hormones, these techniques provided limited removal efficiencies between a few days of operation as a result of the hormones being pumped under high pressure through the membranes. Over time, the adsorbed hormones diffuse through the matrix of RO membranes causing increased penetration of the membranes and/or membrane fouling. Similarly, NF of hormones shows efficacy drops within days depending on the rigors of filtration creating slack in the membrane. Additional disadvantages to RO and/or NF at a point of generation (e.g. compounding pharmacy) include the requirement for additional technologies to first separate or prefilter to remove additional contaminants. In addition, a significant amount of energy and resources are involved in maintaining RO for high removal rates. Still further, RO is pH sensitive, membranes are easily contaminated and clogged by salts, microorganisms and other organics, and the processes are expensive. As a result, RO and NF are not useful for long term hormone remediation.

Endpoint remediation and WWTPs are unable to sufficiently treat hormone contaminants to a level that is not significantly harmful to the environment. As a result, these persistent small toxic compounds are contaminating water sources worldwide.

Bioaccumulation of hormones and EDCs results in adverse reproductive effects such as, skewed sex ratios, infertility, damage of the endocrine system, hormone related cancers and alter the physiology of the brain. Without commercial and/or governmental regulations for removing these difficult to treat compounds there has been a lack of interest in addressing these health and safety concerns. In addition, there has been insufficient improvements to current technology targeted for standard wastewater treatment plants, which remain too expensive and unrealistic at targeting hormones and EDCs within such large volume treatment sources. Therefore, there remains a critical need not yet addressed within the industry and/or by those placing hormones and/or EDCs into water supplies to provide both cost-effective and biologically-effective remediation techniques to remove hormones and/or EDCs from water supplies.

Accordingly, it is an objective of the present invention to provide hormone and/or EDC-generating entities, such as compounding and traditional pharmacies, hospitals, municipalities, residences, medical facilities, pharmaceutical research facilities and universities and other research and development establishments involved in drug research, with effective water remediation methods.

Accordingly, it is an objective of the present invention to develop a-small volume hormone and/or EDC bioreactors employing filtration and biofilm technology for water remediation.

A further object of the present invention is to develop a hormone and/or EDC bioreactor for point of generation and/or point of disposal water remediation.

A further object of the present invention is to develop methods for water treatment providing one or more of the following benefits over currently employed water treatments: increased contact time of hormone and/or EDC substrate with recognized microorganisms, specific to hormone and/or EDC contaminant remediation; increasing removal efficacy over conventional large volume waste water treatment; and enhanced hormone and/or EDC removal from global sewage effluent, bed sediments, ground waters, surface waters and drinking water.

Other objects, advantages and features of the present invention will become apparent from the following specification taken in conjunction with the accompanying drawings.

### BRIEF SUMMARY OF THE INVENTION

An advantage of the invention is the small volume of the bioreactor, allowing remediation to be performed proximal to the source of the hormone or EDC, and before the hormone or EDC can enter large scale water treatment. It is an advantage of the present invention that remediation of the water source has a high level of efficacy because the biofilm of the present invention is tailored to, and continuously tailors to the substrate provided in the wastewater. It is an additional advantage of the present invention that the system requires little energy due to the economical design thereof. It is an additional advantage of the present invention that it provides a “green” technology, requiring no chemical additions, and is safe to handle.

In an embodiment, the present invention includes a method of remediating a water source, comprising obtaining water from a water source containing a hormone and/or endocrine disrupting chemical; exposing said water source to a biofilm, said biofilm comprising hormone-degrading microbes; and thereafter recovering the water having been exposed to said biofilm.

In another embodiment, the present invention includes a method of remediating a water source, comprising obtaining water from a water source; determining whether said water source contains one or more hormones or endocrine disrupting chemicals; selecting one or more hormone degrading microbes that degrade the hormones or endocrine disrupting chemicals; exposing said water source to a biofilm comprising the selected hormone degrading microbes; and recovering the water having been exposed to said biofilm.

In another embodiment, the present invention includes a composition and/or apparatus for remediation of a water source, comprising hormone degrading microbes and activated carbon particles, wherein said hormone degrading microbes form a biofilm on the surface of said activated carbon particles. The apparatus may further include a series of one or more filters (or cartridge) containing the biofilm. The apparatus may further include a series of one or more filters containing activated carbon not inoculated with microbes. The apparatus may further include a reservoir or other type of holding tank for the collection of a water source in need of treatment. The apparatus may further include a series of delivery lines in fluid connection with the tanks and filters of the composition. The apparatus may further include pumps for the flow of water through the delivery lines. The apparatus may further include a backwash loop for regenerating the filters. The apparatus may further include one or more filters for the delivery lines. The apparatus may further include one or more measurement devices for use in the assays according to the invention.

In another embodiment, the present invention includes a kit or system for remediating a water source comprising a receptacle for collecting water, a bioreactor comprising hormone degrading microbe biofilms, and one or more pumps. The kit may further include instructions for use.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a diagram of water remediation at a point of generation and/or disposal according to embodiments of the invention.

FIG. 2 shows a diagram of methods employing a point of generation bioreactor according to an embodiment of the invention.

FIG. 3 shows a diagram of methods regenerating or backwashing a point of generation bioreactor according to an embodiment of the invention.

FIG. 4 shows a diagram of employing a point of generation biofilm application in an agricultural setting for use according to embodiments of the invention.

FIG. 5 shows a diagram of employing a point of generation biofilm application in a septic tank in residential or other locations having toilets, showers and other all-purpose plumbing systems for use according to embodiments of the invention.

FIG. 6 shows a diagram of employing a point of generation filter application in a toilet for use according to embodiments of the invention.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The present invention relates to water treatment systems and methods, including hormone and EDC remediation from water sources. The apparatus, systems and methods have many advantages over WWTPs to remove contaminants such as hormones. For example, in an aspect, a small volume bioreactor is employed and allows hormone remediation (i.e. treatment) to be performed in place. Beneficially, this removes hormones before the water source enters the large scale water treatment, which have been demonstrated to insufficiently remove hormones and/or EDCs. In a further aspect, the reactivity of the bioreactors and methods according to the invention is high due to the biofilm within the bioreactor tailored to the hormone and/or EDC substrate to be treated within the wastewater. In a further aspect, removal of high concentrations of hormones in place reduces the loads on WWTPs. Further benefits according to the invention include, for example, economics, low energy requirements, providing a “green” technology that does not require chemical additions, providing a safe to handle bioreactor that is also “clean” in that the wastewater has not been combined with sewage, which simplifies assaying and treatment, and the like.

The embodiments of this invention are not limited to particular bioreactors and/or applications and methods of use of the same depicted herein, which can vary and are understood by skilled artisans. For example, the technology disclosed herein is further suitable for use in related water remediation methods and techniques. For example, bioreactors may be suitable for use in removing other pharmaceutical contaminants in addition to hormones and EDCs, such as antibiotics, NSAIDS, and other personal care products from wastewater.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The terms “hormones,” “endocrine disrupting chemicals,” and “EDCs,” as used herein, refer to all classes of hormones, including for example natural hormones, bioidentical hormones, and/or synthetic hormones. Examples of natural and bioidentical hormones include estrone (E1), 17b-estradiol (E2), estriol (E3), testosterone, progesterone, DHEA, and pregnenelone. Examples of synthetic hormones include ethinyl estradiol (EE2), mestranol, and diethylstilbestrol (DES). EDCs more broadly refer to any endocrine disrupting chemicals (EDCs), namely those binding to estrogen receptors (or other hormone receptors) which may elicit estrogenic (or other hormone) effects. Examples of EDCs include pesticides, insecticides, fungicides, dioxins, cosmetics, PCBs, DDT, methoxychlor, chlordecone, alkylphenol polyethoxylates (APEs), and their derivatives nonylphenol, octylphenol, and nonylphenol polyethoxylates, natural plants which are estrogenic, such as soy beans, and fungal products, and the like. These and other hormones and EDCs are included within the scope of the disclosed invention.

The terms “microbe,” and “microorganism,” as used herein, refer to any noncellular or unicellular (including colonial) organism. Microorganisms include all prokaryotes. Microorganisms include for example, bacteria (including cyanobacteria and Mycobacteria), lichens, microfungi, protozoa, virinos, viroids, viruses, and some algae. As used herein, the term “microbe” is synonymous with microorganism.

As used herein, “remediation” “water remediation” and “contaminant remediation” refer to the process of removing contaminants from a water supply. In particular, remediation of the present invention encompasses removal of hormones and/or EDCs from a water source, for example a wastewater.

As used herein, the term “wastewater” includes any source of water having hormone and/or EDC-containing contaminants. These include for example, wastewaters generated at pharmacies, pharmaceutical manufacturers, residential locations, waters in or enroute to septic tanks or lagoons, agricultural water run-off and wastewaters, processes or transport waters from such locations, and the like. Such wastewaters also are understood to refer to sources from commercial locations, domestic/residential locations, and the like.

The methods, systems, and apparatuses of the present invention may comprise, consist essentially of, or consist of the components and ingredients of the present invention as well as other ingredients described herein. As used herein, “consisting essentially of” means that the methods, systems, and apparatuses may include additional steps, components or ingredients, but only if the additional steps, components or ingredients do not materially alter the basic and novel characteristics of the claimed methods, systems, and apparatuses.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

### Bioreactor

In an aspect of the invention, a bioreactor suitable for water treatment and remediation of hormones and/or EDCs is provided. As referred to herein, a bioreactor is a device or apparatus comprising hormone degrading microbes. In an aspect, the hormone degrading microbes form a biofilm within the bioreactor.

As referred to herein a bioreactor may vary in shape, size and configuration. For example, in an aspect, the bioreactor is referred to herein as “small volume” for use at a point of generation of hormone-containing waste water. Small volume may include for example, up to at least 10 gallons, up to at least 25 gallons, up to at least 50 gallons, up to at least 100 gallons, or greater. The bioreactors according to the invention may be made of various inert materials, including for example, PVC and/or high density composite. The bioreactor systems may further include additional materials for use in the washers and/or ports for sampling, which may be comprised of rubber, acrylic, and/or glass materials in addition to those same inert materials. In an aspect of the invention, the bioreactor systems do not employ metals in the construction thereof due to reactivity with the chemistries employed.

According to one example of a bioreactor system for a pharmacy compounding 60 hormone containing prescriptions a day, might generate a maximum of 20-40 gallons of wastewater/day. The retention tank/reservoir constructed of an inert plastic or metal material would hold approximately 50 gallons to meet the wastewater remediation needs of such a location. The fixed bed reactors, cylindrical in shape, constructed of inert plastic and/or acrylic would hold approximately 1 kilogram of GAC each, which approximates the volume of 1 Liter. A slightly larger volume would include room for expansion of the packed bed. The flow rate at maximum capacity would be approximately 140 ml/min in this scenario. Conservation of water would be encouraged, thus reducing the volume by half, flow rates can be halved, doubling the concentration of the contaminated wastewater and the residence time or contact time in the reactors, and likely increase removal efficiencies.

As referred to herein a bioreactor is “seeded” or inoculated with hormone degrading microbes. Seeding or inoculation refers to the hormone-degrading microbes being affixed to the activated carbon contained in the biologically activated carbon (BAC) housed within the bioreactor. The bioreactor can be seeded by circulating a suspension of microbes at a flow rate from about 1 ml/min to about 100 ml/min, preferably from about 1 ml/min to about 50 ml/min over a few hours or days, depending on the size of the reactor. In a preferred aspect, the bioreactor is seeded by circulating a suspension of microbes at a very low flow rate, including for example from about 1-10 ml/min, over a few hours or days, depending on the size of the reactor. In an additional aspect, the bioreactor can be seeded by injecting lyophilized microbes (i.e. in their freeze dried state) directly into the reactor primed with a nutrient substrate, allowed to incubate for a few hours and then circulate the nutrients through the reactor for a few hours or days, depending on the size of the reactor. In an additional aspect, the bioreactor could also be seeded from agar slants or petri dishes in a similar manner. In a still further aspect, the bioreactor could also be seeded from microbes isolated or obtained from the site where the bioreactor is to be employed (i.e. obtained from the pipes transporting wastewater from the site of generation).

In an aspect of the invention, the seeded bioreactor remain viable for 1 to 5 years. Fusheng, et al, Adsorption (2008); Guo et al, Journal of Water Resource and Protection (2012). In still further aspects of the invention, seeded bioreactors remain viable for at least 2 years. One skilled in the art will ascertain from the disclosure of the invention the viability of the bioreactor will vary depending upon the size, configuration, rate of use thereof, and other factors which can be modified according to the disclosure provided herein. From a commercial aspect of use of the present invention, a bioreactor system would be provided to a site of generation for use according to the invention in combination with a backup bioreactor, wherein the additional bioreactor is seeded and ready for replacement in the system in the event of bioreactor failure and/or exhaustion of the microbes' efficacy. In an alternative aspect, the bioreactor are also suitable for recycling, regeneration and reloading for reuse within a system upon a failure and/or exhaustion.

The bioreactor employed according to the systems and methods of the invention is comprised of at least one granular activated carbon reactor(s) (GACs) seeded with hormone degrading microbes. In a preferred aspect, a consortium (or plurality) of hormone degrading microbes are employed, such as more than one species and/or strains of the species of hormone degrading microbes. According to the invention, hormone degrading microbes are provided as microorganism communities specific to endocrine disruptor contaminant remediation. Hormone degrading microbes best suited for use in the bioreactors according to the invention include, but are not limited to, aerobic, facultative aerobes, obligate aerobes and denitrifying bacteria. The invention is designed for mesophylic microorganisms whose ideal growth temperatures is generally between 20-45° C.

Exemplary mesophylic microorganisms include proteobacteria. Further exemplary species of hormone degrading microbes include, for example Sphingobacterium sp., Comamonas sp., Nitrosomonas sp., Ralstonia sp., Achromebacter sp., Rhodobacter sp., Rhodococcus sp., Novosphingobium sp., Nitrososomas sp., and Spingomonus sp., Pseudopmonas sp., Pimelobacter sp., Staphylococcus sp.,Pediococcus sp., Enterococcus sp., Brevibacillus sp., Achromobacter sp., Stenotrophomonas sp., Brevundimonas sp., Aminiobacter sp., Bacillus sp., Escherichia sp., Flavobacterium sp., Microbacterium sp., Nocardia sp., and Bacteroidetes sp. Further exemplary hormone degrading microbes, include for example, isolates having previous exposure to hormone contaminants in sediments, water, agricultural waste and activated sludge. Isolates from these sources include, but are not limited to, Sphingobacterium sp. JCRS,Novosphingobium JEM-1, Sphingomonas JEM-1, Nocardosis asteroids, Nitrososomas multiformis, Rhodobacter sp. M2T8B7, Comamonas testosterone strain TDKW, Comamonas nitrativorans (T) 23310, Acinetobacter sp. M1T8B5, Stenotrophomonas maltophilia, Brevundimonas sp. 39 Nitrosomonas europaea, Achromebacter xylosoxidans, Rhodococcus zopfii, Rhodococcus equi., Novosphingobium tardaugens AR-1, and Ralstonia sp. Various deposits of microorganisms have been made by third parties with the

American Type Culture Collection (ATCC), Manassas, Va. 20110 USA. Non-limiting examples of microorganisms suitable for use according to the invention are ATCC Deposit Nos. BAA-1899, 14820, 31191, 31190, BAA-1201, BAA-531, 39523, 700441, 15953, 43050, 49450, 43590, 49622, 55255, 39648, 39770, 51239, 51240, 35215 and 51473. These microorganisms are selected as a result of the Genus, Genus species, or Genus, species and type have been identified as hormone, cholesterol and/or hydrocarbon degraders. Further reason for selecting these particular ATCC deposited cultures is that they were isolated from sludge, activated sludge, sewage, river sediment or agricultural waste after the 1980s, preferably the 1990s to the present time, and are likely to have been exposed to hormones. These deposits are maintained in the ATCC depository, which is a public depository, and owners of such deposits are obligated to replace the same if it becomes nonviable.

In other aspects of the invention, the hormone degrading microbes should be understood to further include functional equivalents of the various microorganisms, including for example fungus and/or algae having hormone degrading effects. An example of a potentially suitable fungus is Fusarium proliferatum. An example of potentially suitable algae are Selenastrium capricornutum, Scenedesmus quadricauda, and Ankistrodesmus braunii.

In an aspect, the biofilm inoculum are diluted to an initial concentration of 10² CFUs/ml (colony forming units) in concentrations to about 10¹⁰ CFUs/ml, preferably from about 10² to about 10⁸ CFUs/ml, and still more preferably from about 10⁴ to about 10⁵ CFUs/ml. The density of the seeded biofilm within the bioreactor will vary, including for example, based on the rate of usage of the biofilm and the amount of substrate (i.e. hormone or other EDCs) fed to the bioreactor. In addition, without being limited according to the invention, all ranges recited are inclusive of the numbers defining the range and include each integer within the defined range.

According to a preferred aspect of the invention, the biofilm is seeded commencing a lag phase of the inoculum, wherein the hormone degrading microbe inoculum are attached to the activated carbon filters during the lag phase. Thereafter a bioreactor has been seeded there is a phase of exponential growth of the hormone degrading microbe inoculum, which thereafter reaches a stationary phase nearing equilibrium of the inoculum growth and nutrient demand. Without being limited to a particular mechanism of action according to the invention, the biofilm within the bioreactor is maintained either at or near such equilibrium phase in order to prevent the death of the biofilm. As one skilled in the art will ascertain from the disclosure of the invention, the death phase is prevented by providing substrate (i.e. hormone or other EDCs) and optimal growing conditions (i.e. dissolved oxygen, pH, temperature) to allow the biofilm within the bioreactor to feed and maintain growth and/or equilibrium.

In aspects of the invention a uniform hormone substrate is remediated from a waste water source, such as remediation at a compounding pharmacy formulating specific hormone products for commercial uses. In such aspects, the remediation of the waste water increases the stability of the biofilm and further increases removal efficiency due to the tailored microbial biofilm for the particular substrate. Slight variability in concentration or types of hormones, as per daily compounding demands, are acceptable and even desirable, as they augment biofilm performance.

One skilled in the art will understand from the disclosure of the present invention that assaying and sampling microbes and other organisms from a wastewater stream and/or piping system may result in the collection of microbes suitable for forming a biofilm within the bioreactors according to the invention.

As referred to herein the hormone degrading microbes form a biofilm within the bioreactor. One skilled in the art understands that biofilms are biological consortiums that contain microorganisms, such as amoeba, algae and bacteria. According to the invention, biofilms are generated within the bioreactor as a result of the hormone degrading microbes establishing on a surface within the bioreactor and producing extracellular polymeric substances (EPS). In addition to polysaccharides, EPS contains proteins, lipids and extracellular DNA. Biofilms are known to be an ideal place for exchange of genetic material. Thus, the composition, architecture and function of the EPS matrix is complex and biologically dynamic since different species produce different EPS. The EPS matrix facilitates sequestering of dissolved and particulate substances (substrate) from the wastewater environment, providing nutrients for biofilm organisms. The microbial inoculum becomes transformed within the bioreactor. The functionality and composition of that biofilm greatly depends on the consortium and the substrate, ultimately creating a microenvironment beneficial to the prolonged maintenance, protection and promotion of a viable biofilm.

The bioreactor systems according to the invention includes one or more filters or filter cartridges for the seeding of a biofilm containing hormone degrading microbes. The bioreactor system may further include additional, non-biofilm seeded filters in addition to the bioreactor. According to such an embodiment, the filters included within the system according to the invention include an activated carbon and the biologically (activated carbon seeded with the hormone degrading microbial biofilm). Without being limited according to a particular mechanism of action according to the present invention, filters are fixed bed continuous flow reactors used to pass the wastewater through to reduce and/or remove the hormones by contacting the wastewater with the filters housing the activated carbon and the activated carbon with hormone degrading microbial biofilm.

In one aspect of the invention, a first filter includes an activated carbon. In some aspects a graphitized activated carbon is utilized as a filter. In some aspects, the filter is a granular activated carbon (GAC) filter. In another aspect of the invention, the filter is contained within the bioreactor, namely a biologically activated carbon (BAC) filter, where the biofilm is affixed to the surface of the carbon medium. Industrial standards for particle size of activated carbon generally define GAC as greater than 1.0 mm in diameter. The range of GAC particle size for purposes of this invention are from 0.05 mm to 100 mm, with GAC particle size preferably from 1.0 mm to 3.0 mm.

Bed size (depth and volume) of the filters employed in the bioreactor systems are dependent on the volume of wastewater to be treated and the flow rate for a particular application of use of a system. According to an exemplary parameter for treating between about 75-150 L/day (20-40 gallons/day) for example of wastewater, at a flow rate of approximately 140 ml/minute would require filters ranging from 1 L to 2 L in size. Treatment rates may vary significantly, including for example from up to about 150 L/day of wastewater, up to about 500 L/day of wastewater, or greater amounts. Similarly, the flow rates for the treatment of such wastewater volumes may vary, including for example up to about 100 ml/minute, up to about 150 ml/minute, or greater rates. Optimization of removal efficiencies dictates flexibility within the arrangement, necessitating significant leeway for manipulating flow rates and bed size in operating such a dynamic system.

In preferred aspects of the invention, the bioreactor system includes a combination of fixed bed filters including both a biological activated carbon (BAC) filter housing the biofilm (i.e. bioreactor) and the granular activated carbon (GAC). Without being limited according to the mechanism of the present invention, the waste water passes through the bioreactor (i.e. BAC), reducing the contaminant predominantly by method of adsorption and biodegradation by hormone/EDC degrading microbes. The effluent from the BAC housing the biofilm) is then passed through the GAC filter further reducing/removing the contaminants predominantly by means of adsorption. In an aspect, the bioreactor system may require one or both of the aforementioned filters in sequence for treating wastewater, depending on the concentration and/or content of contaminant hormones or EDC's.

In an aspect, the bioreactor housing one or more filters further includes one or more pumps for circulating the hormone-containing waste water through the filters described herein for hormone/EDC remediation.

In a further aspect, the bioreactor system further includes plumbing to enable recirculation of wastewater to backwash one or more of the filters according to the invention, which may also be referred to as a “recycle loop.” Such a recycle loop is employed to regenerate the granular activated carbon and/or biofilm-containing filter(s). Such recirculation and recycle loop would include valves and plumbing in fluid connection with the reservoir/retention tank into the filter(s). The recycle loop further includes a backwash filter for collecting impurities from the filter(s) and allowing removal thereof before the wastewater is returned to the reservoir/retention tank.

In an additional aspect, the bioreactor may further include an additional filter, such as a membrane filter to collect breakthrough clumps of organisms before being discharged into the municipal waste water stream or enroute to the GAC. For example, the degraded hormones according to the methods of remediation of the present invention will die off in the natural progression of a biofilm life cycle. The use of additional filters after the treated water passes through the biofilm-containing filters will beneficially remove and collect any clusters of breakthrough organisms to prevent accumulation and clogging of the drainage system. According to such an embodiment, the endpoint filters are replaceable and periodically removed and appropriately disposed of.

### Kits and Bioreactor Systems

The bioreactors according to the invention may be provided in one or more types of kits or systems. In one embodiment of the invention, the system is a set of implements for installation at the point of generation of the wastewater containing hormones and/or EDCs, comprising, consisting of and/or consisting essentially of a receptacle for collecting wastewater (e.g. reservoir or storage tank), a bioreactor (housing one or more rechargeable filters with and without hormone degrading microbe biofilms), optionally an additional housing of one or more rechargeable filters containing activated carbon for adsorption of contaminants from the wastewater, one or more pumps, and instructions on their use for the hormone and/or EDC remediation entity, for installation at the point of generation. In another embodiment of the invention, the composition is a set of implements for installation at the point of generation, comprising, consisting of and/or consisting essentially of a receptacle for collecting water, a bioreactor (housing at least a BAC filter), a GAC filter, assays for the remediation efficacies, and instructions on how to use the kit or system.

In a further aspect, the system may include a source for backwashing a filter within the bioreactor. In a further aspect, the system may include additional components and/or modifications to allow for the assaying of effluent wastewater (i.e. after treatment with the bioreactor and/or at additional points of treatment before, during and/or after the bioreactor system). These and other variations of the kit are included within the scope of the invention.

Kits as referred to herein may be further specified for use with a particular hormone and/or EDC. For example, in an aspect, one or more of the systems described may be provided for remediation of a specific hormone and/or EDC generating product, for instance products and/or bi-products such as pesticides, insecticides, fungicides, PCBs, synthetic hormones, plastics (BPAs), dioxins, cosmetics, and like. Beneficially, providing such kits with the hormone and/or EDC generating product itself provides an end user with the capability to take responsibility for their “own” wastewater by applying the remediating methods pursuant to the present invention to prevent water pollution and/or to comply with future regulations which may control the disposal of such wastewater.

### Applications of Use

Methods of use according to the invention are suitable for various hormone and/or EDC-generating entities. In an aspect water treatment and/or remediation refers to the removal and/or reduction of hormones and/or EDCs from a water source. In an aspect, the bioreactors and methods of use according to the invention provide at least a 50% reduction in hormones and/or EDCs from the water source. Preferably, the bioreactors and methods of use according to the invention provide at least a 60% reduction, at least a 65% reduction, at least a 70% reduction, at least a 75% reduction, at least an 80% reduction, at least an 85% reduction, or at least a 90% reduction (1-log order reduction) in the hormones and/or EDCs from the water source. In a still further aspect, the bioreactors and methods of use according to the invention provide at least a 99% reduction (2-log order reduction), or at least a 99.9% reduction (3-log order reduction), or at least a 99.99% reduction (4-log order reduction), or at least a 99.999% reduction (5-log order reduction) in the hormones and/or EDCs from the water source. In a still further preferred aspect of the invention, the bioreactors and methods of use according to the invention completely remove the hormones and/or EDCs from the water source.

In preferred aspects of the invention the hormone and/or EDC remediation results in a concentration of hormone and/or EDC below at least 10 ng/L, preferably below at least 1 ng/L, and more preferably below at least 0.1 ng/L, and most preferably below at least 0.01 ng/L. In addition, without being limited according to the invention, all ranges recited are inclusive of the numbers defining the range and include each integer within the defined range.

Various water sources may be treated according to the methods of the invention employing the bioreactors and bioreactor systems disclosed according to embodiments of the invention. Water sources may vary substantially with respect to the hardness level, pH, and/or other conditions, all of which are suitable for use according to the present invention. Such water sources may include, for example disposal waters from consumer, commercial and/or manufacturing facilities employing hormones and/or EDCs, sewage effluents from any of the aforementioned sources, agricultural water run offs (or waste water sources), sources of ground waters, and the like.

Without being limited to a particular mechanism of action according to the invention, the methods of the invention beneficially provide increased contact time of a hormone substrate with a defined inoculum of microorganisms for development of a biofilm consortium specific to endocrine disruptor contaminant remediation. In comparison to conventional sewage and community waste water treatment mechanisms, where additional contaminants are found in the water source, as a result there is a significantly reduced interaction between the hormone substrate and the removal mechanism (such as a microorganism for degradation of such hormone). For example, in conventional waste water treatment applications the concentration of hormones and/or EDCs within the wastewater are very low (i.e. dilute), such as between about 10-30 mcg/L, as a result of both the large volume of wastewater to be treated and the additional contaminants within the wastewater. In comparison, the methods of the invention targeting a specific hormone substrate at a location proximate to the contaminant introduction are able to more significantly reduce and/or eliminate the hormone substrate from the water source. In an exemplary embodiment of the invention, the hormone and/or EDC concentration within the wastewater source is substantially more concentrated, such as up to about 2,000 mg/L or greater. In addition, there are generally fewer other types of contaminants in the wastewater according to the invention. Therefore, in an embodiment of the methods of use, the removal of grams/L of the hormone and/or EDCs results in very little (if any) contaminant proceeding into the conventional waste water treatment, in some instances only parts per billion or parts per trillion of hormone and/or EDCs.

In an aspect of the invention, a method of wastewater treatment (including treatment of any of such water sources described herein) and/or a method of hormone and/or EDC remediation from a water sources comprises a collection step, wherein a water source to be treated is collected. In an aspect, the collection step occurs at the source of contaminant introduction, or a location close to the contaminant introduction, into a personal and/or community waste water. For example, in a non-limiting aspect of the invention, a collection step may include obtaining a water source having contact with (and containing) hormones, such as a water source from a compounding pharmacy used to dispose of hormones, used for cleaning instruments in contact with hormones, or the like before such water is disposed into the drain or sewer leaving the facility. Instead, the remediation methods according to the invention beneficially include the collecting of contaminated water at the sink (or wherever it is introduced into the waste water), into a reservoir, retention tank, or the like. Without limiting the scope of the invention, the collection step may be further understood to include the direct delivery of a waste water source into the bioreactor system, without first requiring a storage-based collection step.

According to the invention, the water collection occurs before the waste water is combined with any other sewage source. Beneficially, the hormone degrading bacteria within the bioreactors are not outcompeted for substrate (i.e. hormones) because the biofilm is specific to the contaminant, instead of sewage as occurs in conventional wastewater treatment programs.

The collected hormone-containing wastewater is then pumped into the bioreactor system according to the invention. The water is passed through the bioreactor system for contact with the one or more filters within the system. In an exemplary embodiment, the wastewater is first treated by the bioreactor (i.e. BAC containing the biofilm of hormone degrading microbes) to remediate the hormones and/or EDCs and thereafter treated by the GAC to further remove contaminants. The water is in contact with the biofilm within the bioreactor for a predetermined amount of time. The waste water (i.e. water containing the hormones and/or EDCs) becomes the substrate (i.e. food) for the biofilm such that the biofilm effectively removes the hormones and/or EDCs from the water source. In an aspect, the water is in contact with the biofilm for at least about five minutes, at least about ten minutes, at least about fifteen minutes, at least about twenty minutes, at least about sixty minutes or greater. In some aspects, the water is circulated within the bioreactor, including the BAC and GAC filters for up to one hour, or up to three hours, or more.

The bioreactor system is intended for operation at room temperature. For purposes of economy, energy savings and practicality, the microbial inoculum is mesophilic, prefers temperatures between 20° C. and 45° C.

The bioreactor system is intended for operation under aerobic conditions. In conjunction with substrate, air will be pumped through the reactors of optimized biofilm growth and degradation of hormones.

The contacting of the waste water with the biofilm can include the circulating of the water through the one or more filters housing the biofilm. In one aspect the waste water is combined with oxygen (i.e. aerated), prior to being circulated through the one or more filters to contact the biofilm. In a preferred aspect, the waste water and oxygen are circulated first through the bioreactor (i.e. biologically activated carbon (BAC)) filter followed by further aeration and circulation through the GAC filter housing the biofilm) via a pump.

According to an aspect of the invention, because the hormones and/or EDCs are not adsorbed to “humics”, natural organic matter (NOM) or inorganic components of sewage, adsorption rates in the BAC and GAC filters are increased in comparison to hormones combined in a wastewater source containing other contaminants (i.e. sewage).

According to a further aspect of the invention, the hormones and/or EDCs are not contaminated with significant amounts of organics (i.e. waste water contains low organics). Beneficially, according to the invention a higher rate of hormone degradation and a lower residence time within the bioreactor, specifically within the biofilm-containing filters, is required. In an aspect, the residence time within the bioreactor is between about between about 1 and 5 minutes, and between about 5 and 10 minutes, between about 10 minutes and about 30 minutes, between about 20 minutes and 1 hour or greater for a small volume reactor. The residence time, RT, depends on the size of the reactor, bed depth, biomass and flow rate. Adjustments are made to maximize degradation. According to a further aspect of the invention, the undiluted and consistent source of hormone and/or EDCs at the point of generation provides critical substrate for the biofilm, enhancing and maintaining growth conditions for the desirable hormone degrading microorganisms. High concentrations of hormone substrate promote development of a biofilm capable of surviving and flourishing on those contaminants as their sole carbon source.

According to a further aspect of the invention, the increased surface areas of GAC improves proximity of hormone for adsorption and in the BAC enhances substrate to biofilm opportunities leading to shorter residence times. With more biofilm surface area, capable of sequestering and degrading the contaminant from the waste water, the amount of time it takes for the sequestering/degrading phenomenon to occur is shortened as compared to degradation in an activated sludge of a WWTP.

Additional filters may be employed to treat the incoming water source before the contamination occurs and/or to further treat the treated wastewater before it is released into municipal wastewater. For example, a water source (prior to contamination) may employ water filter and/or softening such as at the tap for removal of chlorine. Removal of chlorine prior to contamination of wastewater eliminates formation of difficult to treat, chlorinated organic compounds, and further eliminates chlorinated degradation products. Softening of the water, where naturally occurring hard water occurs, may extend the use of filters and implements of the bioreactor system by discouraging calcification and fouling. As further example, the treated water may be further filtered for the purpose of capturing breakthrough clumps of biofilm and carbon fines to prevent clogging of pipes.

In an aspect, an assay and/or conventional measuring steps may be further employed throughout the collection, treatment and/or disposal steps set forth according to the invention. In an aspect, the concentration of hormones and/or EDCs may be measured throughout the process. In additional aspects, the pH, temperature, biological oxygen demand (BOD), dissolved oxygen (DO), etc. of the water may be measured throughout the process. Such measurements may be employed for development of customer-specific feedback and predictions for the applications of specific bioreactors suitable for a consumer-specific hormone and/or EDC remediation process. In an aspect, measurements may predict and/or measure contaminant effluents, transport efficiencies, removal efficiencies, and the like.

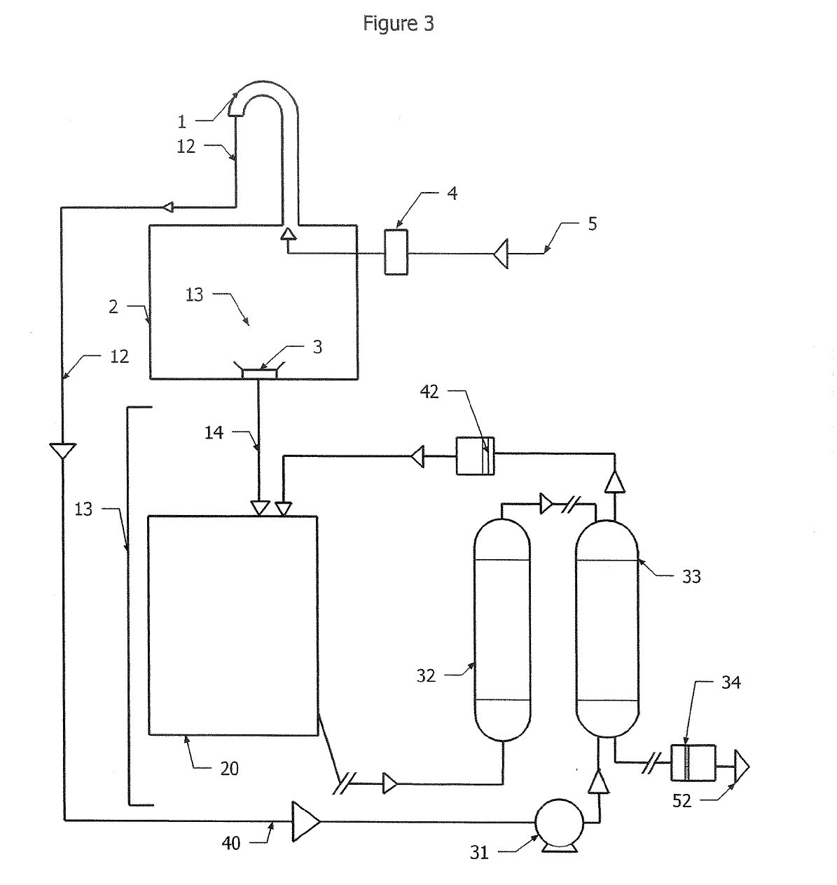

In a further aspect, the methods of the invention may further include the regeneration of filters employed within the bioreactor. In an aspect, a GAC may be regenerated by backwashing of contaminants onto a membrane which is removed for incineration and disposal. An exemplary methodology for backwashing includes where water and air are forced thorugh the fixed bed in reverse, thus flushing the granular activated carbon, desorbing and/or dislodging some of the contaminant, collecting it on a filter and returning the filtered water to the retention tank (such as depicted in FIG. 3). In a further aspect, the GAC may be collected from the implement, baked and dried (i.e. temperatures in the range of 800° C., by means of a qualified entity, to thermally regenerate its adsorptive capacity. In a further aspect, a GAC filter may be regenerated by flushing with high temperature water, above 400° C. In a further aspect, a BAC bioreactor may be regenerated by backwashing with a less vigorous backwash, in the same manner as FIG. 3. In a further aspect, a BAC bioreactor may be regenerated by providing a replacement biofilm to recharge the bioreactor. In this case a BAC bioreactor may be reseeded with the appropriate inoculum. In a further aspect a replacement BAC filter may be conditioned by circulating an appropriate inoculum combined with wastewater from the retention tank to a final concentration of approximately 10⁶ CFUs/ml for no less than 48 hours, according to one embodiment of the methods of use according to the invention. The new BAC is then inserted in place of the existing spent or fouled BAC.

### Depicted Methods of Use

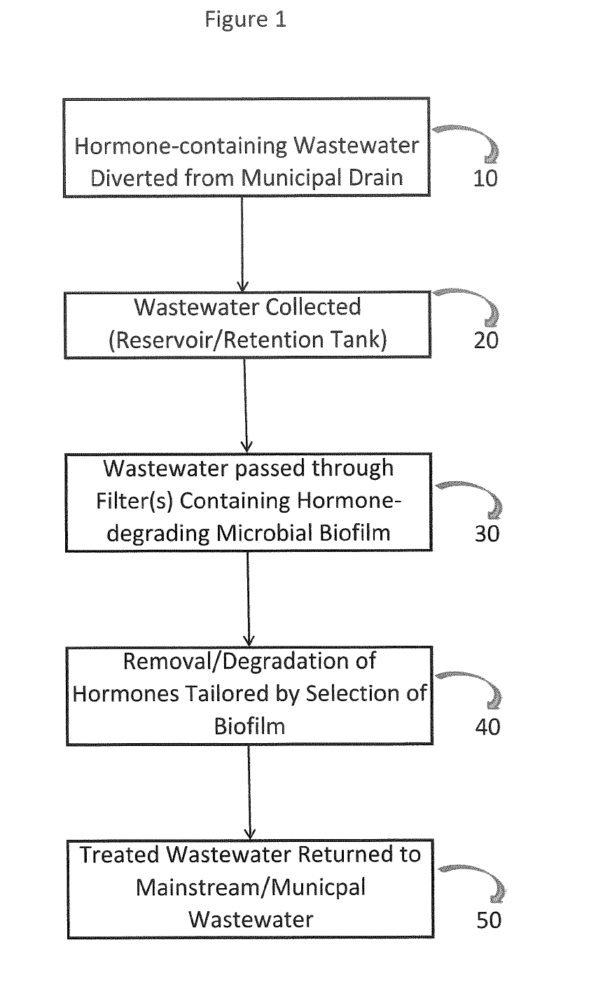

A non-limiting method of use of the hormone remediation and water treatment according to the invention is set forth in FIG. 1. A hormone-containing wastewater is diverted from a municipal drain 10. As disclosed according to methods of the invention, any hormone-containing water source can be employed. When referring to diverting a wastewater source 10, a skilled artisan will understand various mechanisms by which such diversion may occur in order to allow the collection of wastewater into a reservoir or other retention tank 20. The diversion 10 of the wastewater allows its collection 20 prior to entering mainstream/municipal wastewater allowing the targeted and specific remediation employing the bioreactor systems of the present invention. Thereafter the collection of the hormone-containing wastewater 20, it is passed through the bioreactor system containing one or more filters housing the hormone-degrading microbial biofilm (i.e. bioreactor) 30.

Beneficially, the hormones are removed from the wastewater according to the tailored microbial biofilm housed in the bioreactor 40. Finally, the treated wastewater is returned to the mainstream/municipal wastewater having substantially reduced (or eliminated) concentrations of hormones and/or EDCs 50.

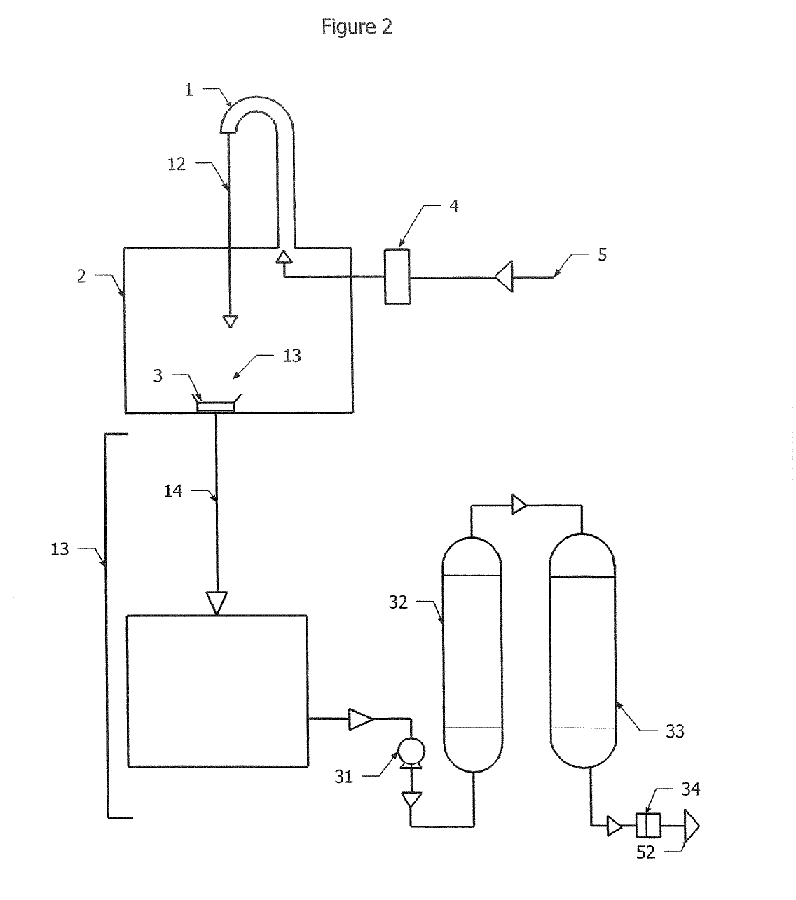

A further non-limiting embodiment employing a method of hormone remediation and water treatment according to the invention is set forth in FIG. 2. As depicted, a faucet 1, sink 2 and drain 3 (as conventionally found in various shapes, sizes and configurations) represent the point of introduction of a hormone and/or EDC contaminant 13 into a wastewater source. The faucet dispenses a water source 12 (which may be optionally treated using a variety of filters, softeners and/or the like 4 from an incoming water source 5) into the sink 2. In the depicted embodiment, the water source 12 dispensed from the faucet 1 is therein contaminated with the hormone and/or EDC contaminant 13 before it enters the drain 3, generating a hormone and/or EDC-containing wastewater 14. Such contamination may occur, for example, while washing dishes, equipment, other articles and the like used in the compounding, manufacturing and hormone disposal. Instead of disposing the contaminated wastewater 14 directly into the municipal wastewater 52 (direct disposal not depicted), the hormone and/or EDC-containing wastewater 14 is directed down a designated sink/drain to a reservoir/retention tank 20. However, in a further non-limiting example of the invention, the wastewater 14 does not require an initial storage or accumulation within the reservoir/retention tank 20; instead the wastewater 14 could be directly treated within the bioreactor system (direct treatment without storage/retention tank not depicted).

As further shown in FIG. 2, the contaminated waste water 14 held within the reservoir/retention tank 20 becomes the substrate (food) for the hormone degrading bacteria employed within the bioreactor system 13. The hormone and/or EDC-containing wastewater 14 is transported from the reservoir/retention tank 20 into a series of one or more filters 32. For example, as depicted in the embodiment of FIG. 2, the hormone and/or EDC-containing wastewater 14 (i.e. substrate) is circulated through two filters within the bioreactor; first a biologically activated carbon (BAC) fluidized bed reactor (i.e. bioreactor) 32, followed by the granular activated carbon (GAC) fluidized bed reactor 33. The hormone degrading microorganisms form a biofilm on the activated carbon particles within the BAC filter within the bioreactor system 13, beneficially increasing the surface area for microorganism growth enabled by the hormone degradation. The hormone and/or EDC-containing wastewater 14 may be circulated through the filter(s) 32, 33 via a peristaltic pump or other similar means 31. A source of air is preferably added to the wastewater 14 when circulating through the filter(s) 32, 33 (i.e. aerated) (not depicted). In an additional aspect, the treated water (i.e. water having been treated by the hormone-degrading microbial biofilm) is then discharged back into the municipal waste water stream 52.

In an additional aspect, the treated water (i.e. water having been treated by the hormone-degrading microbial biofilm) can further go through a final membrane filter 34 before being discharged into the municipal waste water stream 52, for example to collect breakthrough organisms and carbon fines. According to such an embodiment, such endpoint filter is periodically replaced.

A further non-limiting embodiment employing a method of hormone remediation and water treatment further including the backwashing of a filter 33 according to the invention is set forth in FIG. 3. In an embodiment of the invention, the bioreactor system 13 further employs a backwashing mechanism for the GAC filter 33 using a recycle loop 40 to employ the water source 12 from the faucet 1 to regenerate the GAC filter 33. Over time biomass accumulates on the GAC 33 similarly to a BAC 32. Bioactivity has been shown to reduce the adsorptive capacity of the carbon in a GAC, therefore it is desirable to discourage and desorb microorganisms from the GAC in order to facilitate optimal adsorption in that filter. Conversely the BAC is purposed to enhance target microbial growth of a substrate degrading biofilm. Utilizing a combination of both removal technologies will achieve maximum removal. Reduction in adsorption is observed by monitoring dissolved oxygen levels in and out of the GAC. Oxygen is consumed by increased bioactivity. GAC becomes exhausted when the concentration of the contaminant going into the filter is equal to the concentration of the contaminant going out (rate of adsorption=rate of desorption). Analysis of influent and effluent dissolved oxygen and contaminant concentrations will determine time points for backwashing and/or regenerating the GAC.

During a regeneration step, the bioreactor system 13 is not treating the hormone and/or EDC-containing wastewater 14 (shown in FIG. 2). The GAC filter 33 is regenerated by applying the water source 12 to expand and flush out the GAC filter 33. Bed expansion occurs when the activated carbon becomes suspended in the wash water due to the force of the flushing process. When the backwashing is complete the carbon granules settle and normal operation is resumed. During such regeneration step the fluid connections (i.e. valves not depicted in the figure) between the reservoir/retention tank 20 and the GAC filter 32, and from the GAC filter 32 into the BAC cartridge 33 are closed. Instead, the fluid connections (i.e. valves not depicted in the figure) from the water source 12 to the GAC filter 32 are open, effectively forcing desorption and bed expansion in the direction counter to normal flow under the water remediation methods. As a result, the backwash is pushed upward and through a backwash filter 42, wherein impurities are collected on the membrane of the filter 42 and the water is recirculated into the reservoir/retention tank 20 (or may be diverted to a distinct removal or alternative drain). This regeneration process removes biomass and contaminants from the GAC filter 33 and allows for removal and disposal of the backwash filter 42 (e.g. incineration/disposal).

### Agricultural Applications of Use

In an aspect of the invention, agricultural applications of use are particularly suitable. A microbial application in the treatment of hormone contamination from agricultural sources is particularly suitable for use according to the invention, such as dairy and pig and chicken farms. Often livestock are supplemented with growth hormone, treated with hormones for reproductive control or maintained in a state of high estrogen production. Where animals are restricted in concentrated pens or facilities they excrete excessive amounts of hormones. Dairy cows, for example, are sustained in a state of lactation for milk production. As a result, dairy cows excrete large amounts of estrogens daily. Livestock barns house large numbers of animals producing large amounts of high estrogen excrement, which is lagooned and often used in land applications for fertilization and waste disposal purposes. These natural hormone contaminants infiltrate the ground and surface waters. A purpose of this invention is to utilize the consortium of hormone/EDC degrading microorganisms in an application, either wet or dry, into the holding tanks of these facilities or onto the surface of stockyards for example, prior to the waste being pumped (transferred) to lagoons or applied to land.

As with the methods of use disclosed herein, the purpose of this methodology is to sequester, reduce and/or remove the hormones while they are at their highest concentrations. A further advantage is that ample substrate is available not only to support the defined hormone degrading inoculum, but to enhance growth and expansion of these hormone degrading microbes at the point of generation.

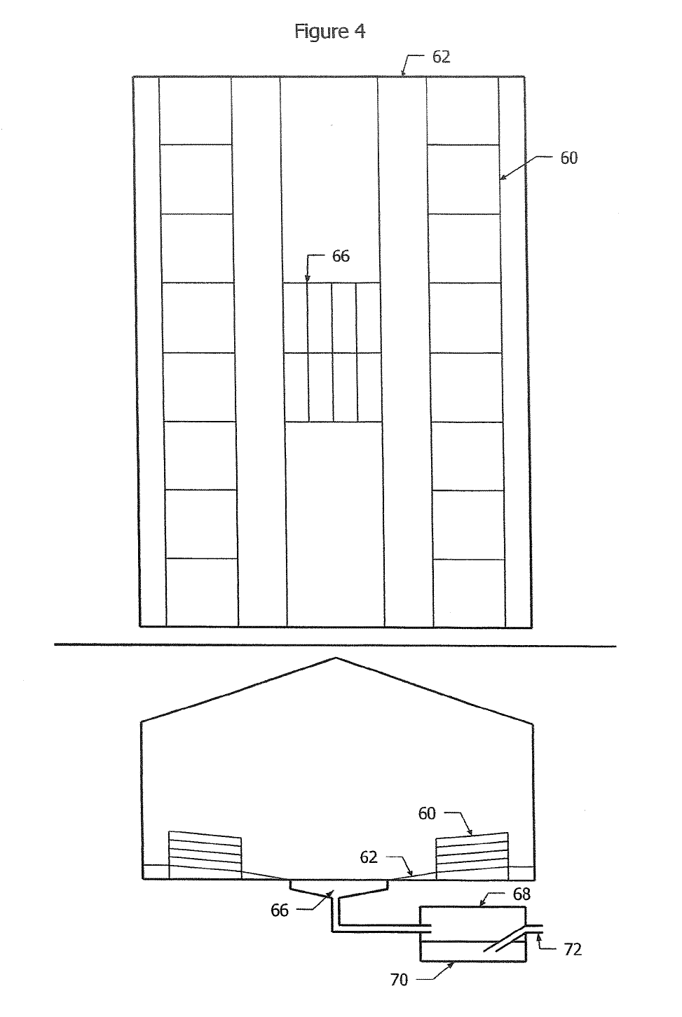

FIG. 4 illustrates a simple, non-limiting model of an application of use of the bioreactors according to the present invention for use in a dairy barn with sloped stalls 60 and gutters 62 on both sides of an alleyway 64. Here excrement is collected and moved to a central drain 66. The drain 66 leads to a holding tank 68 where the waste 70 is pumped to a lagoon 72 awaiting further degradation, drying and potential land application. Microbial application is intended for the drain area 66, where bacteria contact the contaminated waste at its highest hormone and oxygen concentrations are available. In an aspect, the same hormone degrading microbial consortium described for use with the BAC above, may be applied in its dry state; a lyophilized mixture, by scattering it into the drain following excrement removal. In another aspect, the microbial consortium may be applied in a liquid state; whereby the microbes are mixed with water and sprayed into the drain. This procedure may be manually performed at daily, weekly, biweekly intervals, for example, depending on the size of the farming operation. The methods of use according to the invention are further suitable for automation, such as for example, wherein a pump is used to systematically dispense the hormone degrading microbes to the drain area at preprogrammed intervals, using a commercially available unit.

Beneficially, the agricultural applications of use according to the invention removes and/or reduces hormones and/or EDCs from a dairy bar (or other agricultural collection site). In an aspect, the methods of use according to the invention provide at least a 50% reduction in hormones and/or EDCs from the agricultural collection site. Preferably, methods of use according to the invention provide at least a 60% reduction, at least a 65% reduction, at least a 70% reduction, at least a 75% reduction, at least an 80% reduction, at least an 85% reduction, or at least a 90% reduction (1-log order reduction) in the hormones and/or EDCs from the agricultural collection site. In a still further aspect, the methods of use according to the invention provide at least a 99% reduction (2-log order reduction), or at least a 99.9% reduction (3-log order reduction), or at least a 99.99% reduction (4-log order reduction), or at least a 99.999% reduction (5-log order reduction) in the hormones and/or EDCs from the agricultural collection site. In a still further preferred aspect of the invention, the methods of use according to the invention completely remove the hormones and/or EDCs from the agricultural collection site.

### Residential Applications of Use

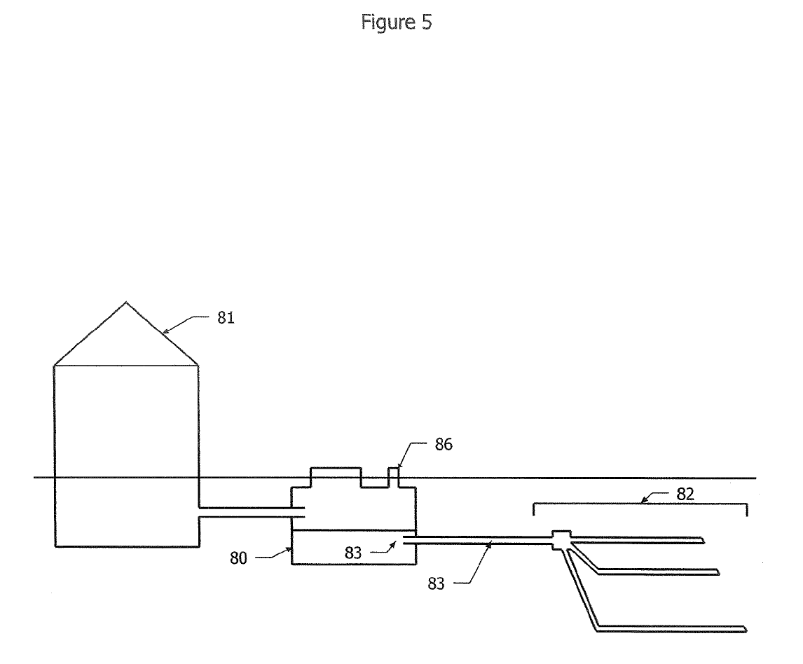

In an aspect of the invention, home (e.g. non-commercial) septic system applications of use are particularly suitable. A microbial application in a similar manner to the agricultural application to residential septic systems is particularly suitable for use according to the invention. In an aspect, residential septic systems may be contaminated with hormones as a result of a person using prescribed hormones for oral hormone replacement therapies (HRTs) and contraceptives via urine and feces. In humans 90% of the hormone's excreted is excreted through urine. HRT's applied transdermally are washed into the septic system by means of bathing and showering. Disposal of HRT and/or other prescription medication through a residential toilet and/or kitchen sink also contribute to increased hormone contaminated waste problems. FIG. 5 illustrates a simplified layout of a septic system including a septic tank 80 and drain field 82. Wastewater from the residence 81 is piped to the underground septic tank 80. As septic levels rise the liquefied waste drains 83 into the pipe 84 leading to the drain field 82. In an aspect, perforated pipes 84 are preferably employed to allow wastewater to seep into the soil. The microbial inoculum is to be administered to the tank contents through an above ground port 86 in the septic tank 80. In an aspect, the same hormone degrading microbial consortium described for use with the BAC above, may be applied in its dry state; a lyophilized mixture, by delivery through the port 86. In another aspect, the microbial consortium may be applied in a liquid state; whereby the microbes are mixed with water and through the port 86. This procedure may be manually performed at daily, weekly, biweekly intervals, for example, depending on the demands on the septic system. The methods of use according to the invention are further suitable for automation, such as for example, wherein a pump is used to systematically dispense the hormone degrading microbes into the tank at preprogrammed intervals, using a commercially available unit.

In an aspect of the invention, a toilet is particularly suited for application of this invention. Toilets having low/high flow options for flushing are becoming increasingly accepted as a method of water conservation in residential, public and commercial buildings. In an aspect, low flow flushing used in conjunction with the modified toilet configuration would allow slightly more contact time with the filter to optimize adsorption of contaminants. In an aspect, a GAC filter strategically placed in the bowl of the toilet would sequester hormones by means of adsorption, removing them from the waste water. In a further aspect of the invention, other pharmaceuticals and personal care products used by persons would be sequestered as well. The filter, filter and cartridge, filter material would require periodic removal, changing and disposal. For example disposal may entail a suitable package, for instance a hazardous waste bag, and disposal instructions included with the packaging of the filter, to provide appropriate disposal measures and routes to incineration. This would discourage unsatisfactory disposal, which would reintroduce the contaminants to the wastewater cycle.

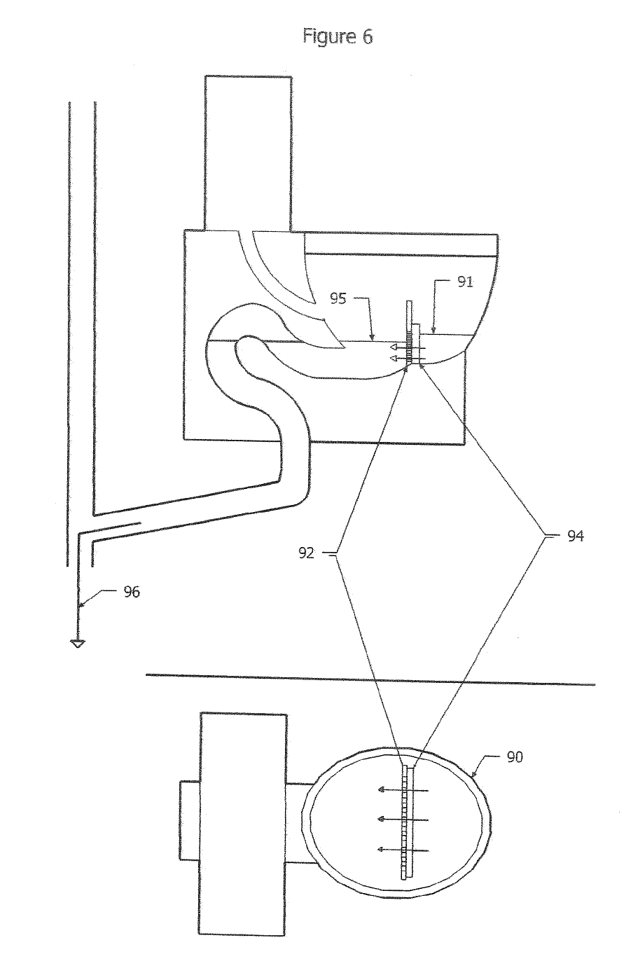

FIG. 6 illustrates the modified toilet with a perforated divider 92 attached to the interior of the toilet bowl 90. The GAC cartridge 94 designed to fit the bowl is situated on the outside of the perforated divider 92 toward the front of the toilet bowl 90 in a catch portion of the toilet bowl 90 for urine 91. The urine 91 is drawn through the filter 94 and the perforated divider 92 mixing with the usual toilet water 95 and/or solids when the toilet is flushed into the sewer 96. In an aspect of the invention, the modified toilet design may be incorporated at the time of manufacturing. In another aspect, an existing toilet may be retrofitted with the design modifications for the purposes of capturing hormones, EDCs and other personal care products and pharmaceuticals.

Beneficially, the residential applications of use according to the invention removes and/or reduces hormones and/or EDCs from a toilet in residential, public and commercial buildings. In an aspect, the methods of use according to the invention provide at least a 50% reduction in hormones and/or EDCs from the collection site. Preferably, methods of use according to the invention provide at least a 60% reduction, at least a 65% reduction, at least a 70% reduction, at least a 75% reduction, at least an 80% reduction, at least an 85% reduction, or at least a 90% reduction (1-log order reduction) in the hormones and/or EDCs from the collection site. In a still further aspect, the methods of use according to the invention provide at least a 99% reduction (2-log order reduction), or at least a 99.9% reduction (3-log order reduction), or at least a 99.99% reduction (4-log order reduction), or at least a 99.999% reduction (5-log order reduction) in the hormones and/or EDCs from the collection site. In a still further preferred aspect of the invention, the methods of use according to the invention completely remove the hormones and/or EDCs from the collection site.

### Assays

In an aspect of the invention, assays for target hormones and/or EDCs may be developed for monitoring influents and effluents, and bioreactor performance. In one aspect, assays for target hormones detect hormone and/or EDC concentrations to determine the optimal remediation conditions for a particular application or setting. For example, an assay may allow the selection of particular microbes to seed into the bioreactor, or the shape, size and configuration of the bioreactor by determining the concentrations of EDCs in the water source, in the influent, or in the effluent. In one embodiment the assay allows for selection of microbial combinations suitable for remediation of a particular contaminant, such as the type and/or concentration of particular microbes. In another aspect, the assays for target hormones and/or EDCs detect hormone and/or EDC concentrations to determine whether a remediation system is operating effectively. For example, an assay may be used to maintain a viable and sustainable biofilm. For example, an assay may detect the EDC the bioreactor is intended to remove from the water source, or may detect a metabolite of the EDC the bioreactor is intended to remove, or may detect an indicator of biofilm health.

In another aspect, the assays for target hormones and/or EDCs are used to assess the application methods and to determine the efficacy thereof. The assay may determine the presence of individual components of the bioreactor or products of particular method steps.

In an aspect, enzyme linked immunosorbent assay (ELISA) assays specific for target hormones/EDCs may be employed. The ELISA assays may be commercially available, or may be prepared specifically for applications according to the present invention. In an embodiment of an ELISA method, the method may include: (i) coating a surface of a solid substrate with a sample to be analyzed; (ii) incubating the sample with an antibody specifically binding to the target hormone and/or EDC as a first antibody; (iii) incubating the resultant product with a secondary antibody conjugated to an enzyme; and (iv) measuring the activity of the enzyme.

In another aspect, gas chromatography/mass spectrometry (GC/MS) may be employed. Mass spectrometry (MS) is a well-known technique of obtaining a molecular weight and structural information about chemical compounds. Using mass spectrometry techniques, molecules may be weighed by ionizing the molecules and measuring the response of their trajectories in a vacuum to electric and magnetic fields. Ions are weighed according to their mass-to-charge (m/z) values.

### Benefits of Remediation

This invention addresses the removal and remediation of mass quantities of hormones and EDCs at the point of generation. It is a feasible, economic and green solution to reduction of contaminant loading on conventional wastewater treatment plants (WWTPs) to a manageable realistic treatment level. The invention addresses global findings and forebodings of reproductive interference resulting from widespread hormone and EDC contamination due to increased demand, production and use of these environmental toxins.

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

A compounding pharmacy produces 40 gallons of hormone wastewater per day. Hours of operation are 9 am-5 pm, 5 days a week. The average concentration of hormone waste to the retention tank is 10 mg/L (CO). The bed volumes of both the BAC (Vb) and GAC(Vg) are 400m1 and the full reactor sizes are each 600 ml, (VB and VG). After flowing through the BAC the concentration (Ci) of hormones is 30 micrograms/L (3.0×10-2 mg/L) and after flowing through the GAC the concentration (Ce) is 0.01 nanograms/L (1.0×10-8 mg/L) returned to the municipal wastewater stream. Example 1 is a simple demonstration for calculating reactor size based on desired flow rate and Empty Bed Contact Time.
GAC particle size is 1.0 mm and bulk density of 1.0 mm GAC (d) is 0.5 g/cc
Empty bed contact time, EBCT (t) is 5.5 min
Maximum flow rate (Q in reactors is 75 ml/min
Volume of water to be treated (VR)

40 gal/d (3.785 L/gal)=150 L/d

150 L/d (5 d/wk)=750 L/wk

VR=750 L/wk/7 d/wk=107 L/d contaminated wastewater for continuous flow
Maximum flow rate (Q)

Q=107 L/d(1 d/24 hr)(1 hr/60 min)(1000 ml/L)=75 ml/min
BAC bed volume (Vb)
Vb=EBCTb×Q=5.5 min×75 ml/min=412 ml
BAC total volume (VB)

VB=Vb/66%=412 ml/0.66=624 ml
Bed height (h) if internal radius (r) of column is 2.5 cm

hb=Vb/(π×r2)=412 cc/(π×6.25 cm2)=21 cm
BAC total height (ht)

ht=VB/(π×r2)=624/(π×6.25 cm2)=32 cm
Bed mass (M)

M=Vb/d=412 cc×0.5 g/cc=206 g GAC

This is a simplified example assuming first order degradation rates, k, which may differ for the GAC and BAC filtering components, thus the size of the 2 reactor filters may differ. To maximize adsorption in the GAC, a biweekly backwash schedule may be adequate for a system of this size.

### Example 2

In a dwelling, resides a family including a female of reproductive age using synthetic estrogen (i.e.EE2) dosed a 35 mcg/day orally for purposes of birth control. In addition there is a post menopausal female relative that lives in the dwelling. She uses progesterone (200 mg/d), estradiol (2 mg/d) and testosterone (2 mg/d) prescribed by her physician for controlling menopausal symptoms. An estimated 90% of hormones are excreted through the urine in humans.

### Ex. 2.0

0.0035 mg (EE2)+20 mg (P)+2 mg (E2)+2 mg (T)=200.0035 mg hormone consumed

200.0035 mg×0.90=183.60315 mg/day hormone excreted

183.60315 mg/d×365 d/yr=67,015.14975 mg/year=67.015 grams/year

GAC cartridges utilized in a modified toilet designed for the adsorption of synthetic and bioidentical hormones would sequester the hormones, thus removing them from the wastewater at the point of introduction into the community wastewater treatment system. In addition, any over the counter ibuprofen, for example consumed would be removed as well. In this example the home owner takes responsibility for his/her own contaminant waste and the burden of their prescription use is removed from the WWTP. The GAC cartridge comes with its own hazardous waste bag and instructions for proper disposal at a local drug collection site. Recommended replacement for the GAC cartridge is every 3 months, for example. Depending on average number of flushes/day.

There are approximately 62 million woman of child bearing age in the United States as of August 2013. 62% of those women use contraception (i.e. 38,440,000). 64% (24,601,600) of women using contraception use hormonal methods.

### Ex. 2.1

24,601,600×35 mcg/d (an average dose)=861056000 mcg/day=861.056 gram/day

861.056 g/d×365d/yr=314,285 g/yr

That may not seem like much but when reminded of the fact that hormones are bioactive in nanograms (1 nanogram=0.0000000001 gram) the ramifications are staggering.

### Ex. 2.2

In 2010 there were 30,246,432 women aged 50-64 in the United States, according to the US Census Bureau. An estimated 1 in 3 women in that age group use hormone replacement therapy which is 10,082,144. If roughly 10 million women are excreting 90 mg hormone/day, that is 907.4 kg/day, or 331,198.43 kg/year. (Does not include women over 64 or men using testosterone.)

### Example 3

In 2006 the US dairy cow population produced 80 tons (72,574.8 kg) of estradiol (E2) alone per year, (2060 mcg/cow/day). If microbial application to dairy cattle excrement could reduce that number even by 50%, it would significantly reduce the estrogen loads on the environment.

The above specification provides a description of the systems and applications of use thereof for water treatment. The inventions being thus described, it will be obvious that the same may be varied in many ways. Such variations are not to be regarded as a departure from the spirit and scope of the inventions and all such modifications are intended to be included within the scope of the following claims.

What is claimed is:

1. A method of remediating a water source, comprising:
obtaining a water source containing hormone(s) and/or endocrine disrupting chemical(s) (EDCs) at or near a point of contamination;
exposing said water source to a consortium of hormone and/or EDC degrading microbes; and
reducing the concentration of said hormone(s) and/or EDCs in said water source having been contacted with said consortium.

2. The method of claim 1, wherein said consortium of hormone and/or EDC degrading microbes forms a biofilm, and wherein water source containing hormones and/or EDCs is a substrate for said biofilm.

3. The method of claim 1, wherein said wastewater source is any wastewater generated at a pharmacy, pharmaceutical manufacturer, residential location, waters in or enroute to septic tanks or lagoons, agricultural water run-off and wastewaters, process or transport waters from such locations, and combinations thereof

4. The method of claim 1, wherein said hormone degrading microbes are mesophylic microorganisms.

5. The method of claim 1, further comprising a step of seeding a bioreactor with said hormone degrading microbes, wherein said bioreactor comprises said biofilm seeded onto a granular activated carbon filter surfaces.

6. The method of claim 5, wherein said bioreactor is regenerated by recirculating said water source onto said filter(s) surface (i.e. recycle loop) to regenerate said biofilm-containing granular activated carbon filter(s).

7. The method of claim 1, wherein said remediation methods reduce the hormone and/or EDCs in said water source by at least about 90% (1-log order reduction).

8. A method of remediating a water source at a point of contamination, comprising:
obtaining a water source;
determining whether said water source contains one or more hormones and/or endocrine disrupting chemicals (EDCs);
selecting one or more hormone degrading microbes that degrade the hormones and/or EDCs;
exposing said water source to a bioreactor comprising a biofilm of said selected hormone degrading microbes on a granular activated carbon filter; and
reducing the amount of hormones and/or EDCs in said water source after having been exposed to said biofilm by at least about 90% (1-log order reduction).

9. The method of claim 8, wherein said hormone degrading microbes are mesophylic microorganisms selected from the group consisting of aerobic microbes, facultative aerobic microbes, obligate aerobic microbes, denitrifying bacteria and combinations of the same.

10. The method of claim 8, wherein at least about 50 L/day of said water source are remediated with said bioreactor.

11. The method of claim 8, wherein said remediation methods reduce the hormone and/or EDCs in said water source by at least about 99% (2-log order reduction).

12. The method of claim 8, further comprising a step of seeding said hormone degrading microbes onto a bioreactor, wherein said water exposed to said biofilm is passed through said bioreactor seeded with said hormone degrading microbes.

13. An apparatus for remediation of a water source, comprising:
a receptacle for collecting water; and
a bioreactor comprising at least one granular activated carbon particle filter seeding with hormone degrading microbes;
wherein said hormone degrading microbes form a biofilm on the surface of said activated carbon particle filter forming a biologically activated carbon filter.

14. The apparatus of claim 13, wherein said receptacle for collecting water holds at least 10 gallons of said water.

15. The apparatus of claim 13, wherein said receptacle for collecting water holds at least 25 gallons of said water.

16. The apparatus of claim 13, wherein said bioreactor housing said hormone degrading microbes has a viability of at least 1 year.

17. The apparatus of claim 13, further comprising a non-biologically activated carbon filter.

18. The apparatus of claim 13, wherein said hormone degrading microbes are mesophylic microorganisms.

19. The apparatus of claim 13, wherein said hormone degrading microbes are aerobic microbes, facultative aerobic microbes, obligate aerobic microbes and/or denitrifying bacteria.

20. The apparatus of claim 13, further comprising at least one delivery line in fluid connection with said receptacle for collecting said water (e.g. tank) and said bioreactor.
